(19) United States
(12) Patent Application Publication
(10) Pub. No.: US 2011/0011838 A1
(43) Pub. Date: Jan. 20, 2011

(54) Method for fabricating semicoductor wafers applicable to integrated circuit manufacture

(76) Inventor: Shu-Ling Kuo, Su-ao Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/458,573

(22) Filed: Jul. 16, 2009

(51) Int. Cl. B23K 26/00; B28D 1/02; B24B 1/00

(52) U.S. Cl. 219/121.66; 125/12; 451/41

(57) ABSTRACT

The present invention discloses a method for fabricating semiconductor wafers applicable to IC manufacture, which comprises steps: providing an ingot; slicing the ingot into a plurality of wafers; using a laser to illuminate the surface of the wafers to eliminate the saw marks generated by slicing and fuse the microcracks on the surface of the wafers; pickling, polishing and inspecting the wafers. The present invention uses intensive laser energy to remove saw marks generated by slicing and fuse microcracks generated by stress. Thereby, the effect of isotropic etching is reduced in the succeeding pickling procedures, and the damage layer is minimized. Thus, the thickness of the removed material is reduced, and a single ingot can be sliced into more wafers.

### BACKGROUND OF THE INVENTION

1. Field of the Invention

The present invention relates to a wafer surface treatment technology, particularly to a method for fabricating silicon wafers applicable to IC manufacture.

2. Description of the Related Art

To form silicon wafers used in IC manufacture, a columnar silicon ingot must be processed with various mechanical processes. Refer to FIG. 1 a flowchart of the conventional process for fabricating semiconductor wafers applicable to IC manufacture. In Step S1, a silicon ingot is provided. In step S2, the silicon ingot is sliced to form wafers. At this time, the wafers have saw marks thereon. The saw marks have a maximum height difference measuring about 14-16 μm from a single side of a wafer, or about 30-45 μm from both sides of a wafer. In Step S3, the wafers are pickled to eliminate stress and surface impurities, deepen cracks, and soften material structures to facilitate the succeeding grinding procedures. In Step S4, lapping and/or grinding are undertaken. Then, the wafers are processed with Step S5 of cleaning, Step S6 of polishing, Step S7 of cleaning, Step S8 of inspection, etc. to form silicon wafers applicable to IC manufacture. In the abovementioned process, as thick as 130-150 μm of material is removed from the surfaces of a wafer to eliminate saw marks and damage layers generated in pickling. Thus, most of the thickness of a wafer is expended in removing damage layers caused by the isotropic etching in pickling. Then, a greater thickness must be reserved for the succeeding grinding procedures in wafer slicing. Consequently, fewer wafers are obtained from a silicon ingot. Accordingly, the present invention proposes a method for fabricating semiconductor wafers applicable to IC manufacture to overcome the abovementioned problem.

### SUMMARY OF THE INVENTION

The primary objective of the present invention is to provide a method for fabricating semiconductor wafers applicable to IC manufacture, wherein after a silicon ingot is sliced into wafers, the entire surface of the wafers is illuminated with laser to remove the saw marks on the surface and fuse the microcracks, whereby are decreased the microcracks and the height difference of the saw marks, and whereby the thickness of the damage layer is minimized because the microcracks have been fused, and whereby the total thickness of the removed material is reduced, wherefore a single ingot can generate more wafers, and wherefore the process consumes less liquid chemical agent and has higher productivity.

To achieve the abovementioned objective, the present invention proposes a method for fabricating semiconductor wafers applicable to IC manufacture, which comprises steps: providing an ingot; slicing the ingot into a plurality of wafers; using a laser to illuminate the surface of the wafers to eliminate the saw marks generated by slicing and fuse the microcracks on the surface of the wafers; pickling, polishing and inspecting the wafers.

Below, the embodiments are described in detail to make easily understood the objective, technical contents, characteristics and accomplishments of the present invention.

### BRIEF DESCRIPTION OF THE DRAWINGS

FIG. 1 is a flowchart of the conventional process for fabricating semiconductor wafers applicable to IC manufacture;

FIG. 2 is a flowchart of a method for fabricating semiconductor wafers applicable to IC manufacture according to the present invention;

FIG. 3 is an OM (Optical Microscope) photograph of the recessed on the surface of a wafer after laser fusion according to the present invention;

FIG. 4 is an OM (Optical Microscope) photograph of the raised areas on the surface of a wafer after laser fusion according to the present invention;

FIG. 5 is an OM (Optical Microscope) photograph of the surface of a wafer without laser fusion; and

FIG. 6 is an OM (Optical Microscope) photograph of the surface of a wafer without laser fusion after laser fusion according to the present invention.

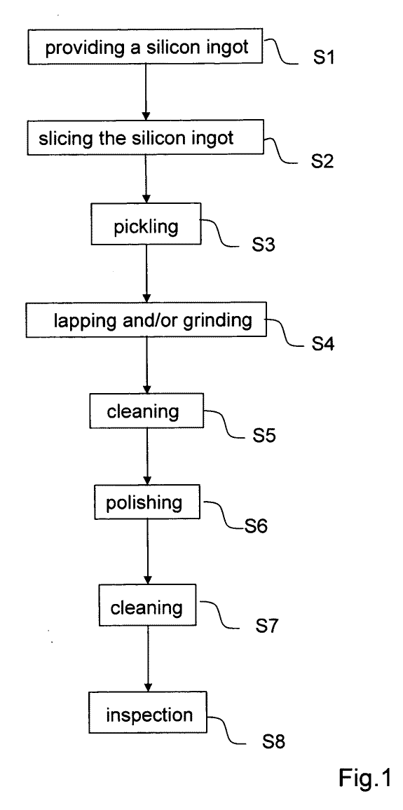

### DETAILED DESCRIPTION OF THE INVENTION

The spirit of the present invention is to use intensive laser energy to remove saw marks on the surface of wafers and fuse microcracks generated by stress. Thereby, the effect of isotropic etching is reduced in the succeeding pickling procedure, and the damage layer is minimized. Then, the lapping/grinding procedure can be omitted, and the thickness of the removed material is reduced. Thus, a single ingot can be sliced into more wafers.

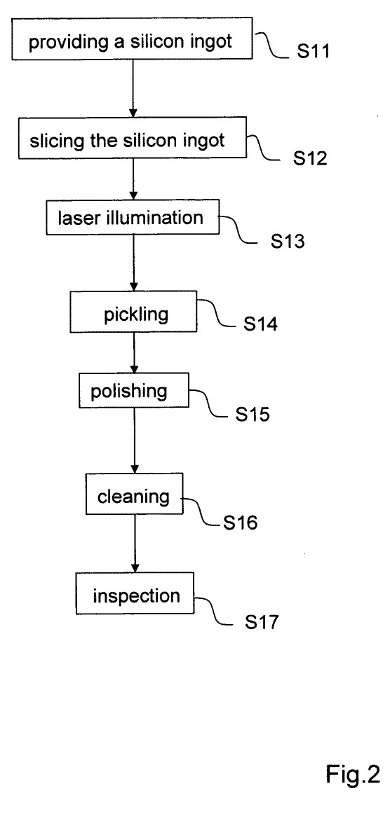

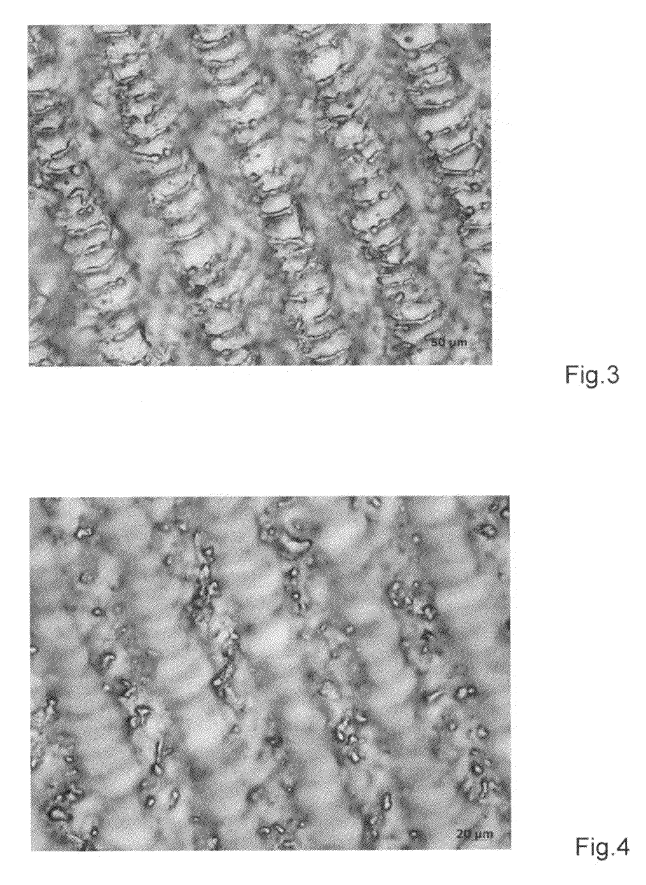

Refer to FIG. 2 a flowchart of a method for fabricating semiconductor wafers applicable to IC manufacture according to the present invention. In Step S11, a silicon ingot (or a germanium ingot or a gallium arsenide ingot) is provided. Next, in Step S12, the silicon ingot is sliced into wafers. Next, in Step S13, a laser having a wavelength of 309-2140 nm is used to illuminate the entire surface of a wafer in a single-pass scanning mode or a multi-pass scanning mode to remove saw marks on the surface of the wafer and fuse microcracks on the surface of the wafer, as shown in FIG. 3 and FIG. 4. Next, in Step S14, the wafer is pickled to eliminate stress and surface impurities and soften the material structures to facilitate the succeeding grinding procedures. Next, in Step S15, the wafer is polished. Next, in Step S16, the wafer is washed to remove the polishing agent or polishing slurry. Next, in Step S17, the wafer is inspected. Then, the wafers applicable to IC manufacture are completed and delivered to the customers.

After the illumination of laser, the saw marks have a maximum height difference measuring about 1-2 μm from a single side of the wafer. Even measuring from both sides of the wafer, the maximum height difference of the saw marks is only about 2-4 μm. In comparison with the conventional technology having a maximum height difference measuring about 14-16 μm from a single side and a maximum height difference measuring about 30-45 μm from both sides, the present invention obviously decreases the height difference of saw marks and greatly improves the surface roughness of the wafer. Further, as the laser illumination also fuses the microcracks, the damage layer, which is caused by the isotropic etching in pickling, is minimized and less thick than in the conventional technology.

As the total thickness of the material to be removed is only 10-20 μm, the lapping/grinding step may be omitted in the present invention. However, omitting the lapping/grinding step is neither the characteristic nor the focus of the present invention. Whether to omit the lapping/grinding step is still dependent on the requirement of the process.

Via the present invention, each unit of ingot can generate more wafers by about 20%. Further, the present invention can reduce the consumption of liquid chemical agent by about 50% and promote the productivity by about 60%.

Table.1 shows the height differences before and after the laser illumination. The experiment to establish Table.1 adopts a green laser with a wavelength of 532 nm. However, the laser used by the present invention is not limited to the green laser but may be a laser having a wavelength of between 309 and 2140 nm, including a violet laser, a red laser, etc.

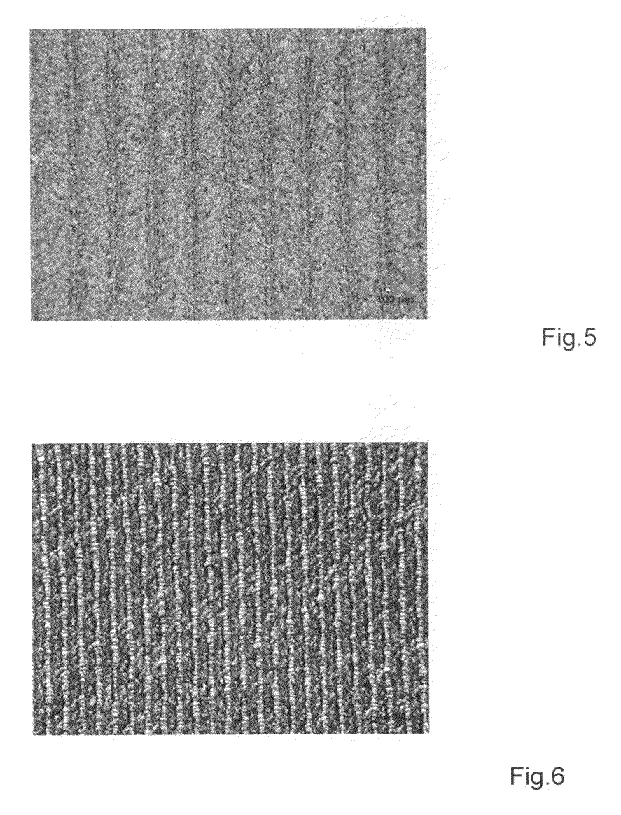

TABLE 1

| | | | Before | After Laser |
|---|---|---|---|---|
| | | | Laser | Illumination |
| | Wafer | Scanning | Illumination | (as shown in |
| | Thickness | Speed/Scanning | (as shown | FIG. 3, FIG. 4 |
| Wafer No. | (μm) | Mode | in FIG. 5) | and FIG. 6) |
| 1 | 669.73 | 1200/single | maximum | maximum |
| | | pass | height | height |
| 2 | 664.17 | 1200/single | difference | difference |
| | | pass | on a single | on a single |
| 3 | 669.07 | 1200/single | side | side |
| | | pass | 12-15 μm | 1-2 μm |
| 4 | 667.62 | 800/single pass | | |
| 5 | 666.69 | 1200/single | | |
| | | pass | | |
| 6 | 663.66 | 1200/multiple | | |
| | | passes | | |

The embodiments described above are only to exemplify the present invention but not to limit the scope of the present invention. Any equivalent modification or variation according to the spirit of the present invention is to be also included within the scope of the present invention.

What is claimed is:

1. A method for fabricating silicon wafers applicable to integrated circuit manufacture comprising steps:
providing an ingot;
slicing said ingot into a plurality of wafers;
using a laser to illuminate surface of said wafers to remove saw marks generated by slicing and fuse microcracks on surface of said wafers; and
pickling, polishing and inspecting said wafers.

2. The method according to claim 1, wherein said ingot is made of silicon, gallium arsenide, or germanium.

3. The method according to claim 1, wherein said laser has a wavelength of between 309 and 2140 nm.

4. The method according to claim 1, wherein said laser is a green laser having a wavelength of 532 nm.

5. The method according to claim 1 further comprising a step of lapping/grinding said wafers after pickling said wafers and before polishing said wafers.

6. The method according to claim 1 further comprising a step of cleaning said wafers after polishing said wafers and before inspecting said wafers.

7. The method according to claim 1, wherein said laser illuminates said surface of said wafers in a single-pass scanning mode or a multi-pass scanning mode.
